(19) United States
(12) Patent Application Publication
(10) Pub. No.: US 2019/0075632 A1
(43) Pub. Date: Mar. 7, 2019

(54) Illumination Device

(71) Applicant: Bayerische Motoren Werke Aktiengesellschaft, Muenchen (DE)

(72) Inventors: Robert ISELE, Fuerstenfeldbruck (DE); Juergen BRUEGL, Muenchen (DE); Florian ALTINGER, Shenyang/Heping District (CN)

(21) Appl. No.: 16/178,945

(22) Filed: Nov. 2, 2018

Related U.S. Application Data
(63) Continuation of application No. PCT/EP2017/059752, filed on Apr. 25, 2017.

(30) Foreign Application Priority Data
May 4, 2016 (DE) 10 2016 207 730.9

(51) Int. Cl. H05B 33/08; B60Q 3/80; B60Q 1/00

(52) U.S. Cl. CPC H05B 33/0863; H05B 33/0851; H05B 33/0818; B60Q 1/0088; B60Q 3/80

(57) ABSTRACT

An illumination device, in particular for a motor vehicle, includes one or more multi-color LED units which each have a settable color point and a settable brightness. Each multi-color LED unit is an individual semiconductor component having multiple single-color LEDs of different colors and a microcontroller, wherein the single-color LEDs and the microcontroller are surrounded by a housing of the semiconductor component. Calibration data which describe a dependency of at least one color point and at least one brightness of the associated multi-color LED unit on operating currents of the single-color LEDs are stored in the microcontroller. The microcontroller is designed to control each single-color LED depending on a set color point and a set brightness of the associated multi-color LED unit by setting the operating currents of the associated single-color LEDs using the calibration data.

### CROSS REFERENCE TO RELATED APPLICATIONS

This application is a continuation of PCT International Application No. PCT/EP2017/059752, filed Apr. 25, 2017, which claims priority under 35 U.S.C. § 119 from German Patent Application No. 10 2016 207 730.9, filed May 4, 2016, the entire disclosures of which are herein expressly incorporated by reference.

This application contains subject matter related to U.S. patent application Ser. No. ______, (Attorney Docket No. 080437.PB347US) and U.S. patent application Ser. No. ______, (Attorney Docket No. 080437.PB354US) both entitled “Illumination Device” and filed on even date herewith.

### BACKGROUND AND SUMMARY OF THE INVENTION

The invention relates to an illumination device, in particular for a motor vehicle.

It is known in the prior art to use multi-color LED units for illumination devices in motor vehicles. These LED units comprise a plurality of single-color LEDs and are generally controlled by LED drivers to vary the brightness and the color point (e.g. the mixed color). Used to this end is a module having a microprocessor that communicates with a motor vehicle databus and additionally drives the LED units, typically via PWM outputs. A suitable motor vehicle databus used frequently here is what is known as a LIN bus (LIN=local interconnect network).

Furthermore, novel multi-color LED units that have an integrated circuit are known from the prior art. In these LED units, the single-color LEDs and the integrated circuit are accommodated in a common package, as a result of which a high packing density can be achieved. The individual LED units are controlled via a data stream.

Until now, parameterizations, required in illumination devices with multi-color LED units for operating the individual LED units, are stored in a central processing module. This has the disadvantage that locally varying operating conditions of the individual LED units can be only insufficiently compensated, which can result in a non-uniform appearance of the illumination device.

To ensure that a multi-color LED unit emits light having a desired mixed color, a calibration of the corresponding multi-color LED unit is frequently performed. Here, one or more predetermined color points and possibly also brightnesses of the multi-color LED unit are set and the actual color points or brightnesses are captured using a calibration sensor. In addition, the operating currents that result for the single-color LEDs in the multi-color LED unit are measured for the respective set color points or brightnesses. The assignment of these operating currents to the color points or brightnesses then represents calibration data, on the basis of which the desired color points or brightnesses can be set during later operation of the multi-color LED unit.

In document DE 10 2006 037 292 A1, the calibration of an LED light module is described, in which intensity values of the individual LEDs of the light module for a specified color point are captured using a sensor in the light module. The color point is measured by a calibration sensor outside the LED module. The captured intensity values are stored in a controller of the LED module in the form of calibration data. During the operation of the LED module, the measured intensity values of the sensor are set using the calibration data such that the desired color point is achieved.

Document WO 2011/106661 A1 describes a calibration method for an LED light system. The calibration data are stored in the form of a look-up table which is accessed during the operation of the LED light system.

It is the object of the invention to provide an illumination device of at least one multi-color LED unit with simple controlling and a simple method for producing such an illumination device.

This object is achieved by way of an illumination device and a method of producing same in accordance with embodiments of the invention.

The illumination device according to the invention is preferably provided for a motor vehicle, such as a passenger car and possibly also a truck. The illumination device comprises one or more multi-color LED units which each have a settable color point and a settable brightness (i.e. light intensity). The term color point is well known to a person skilled in the art and describes the mixed color produced by the respective multi-color LED unit. The color point can be given for example as a point in a chromaticity diagram, in particular in a chromaticity diagram of the CIE color space.

In the illumination device according to the invention, each multi-color LED unit is an individual semiconductor device having a plurality of, and preferably at least three, single-color LEDs of different colors. The individual semiconductor device furthermore comprises a microcontroller. The single-color LEDs and the microcontroller are enclosed by a package of the semiconductor device, i.e. they are accommodated in a common package of the semiconductor device.

In the illumination device according to the invention, calibration data are stored in the microcontroller that describe a dependence of operating currents of the single-color LEDs on at least one color point and at least one brightness of the respective multi-color LED unit. To this end, the microcontroller is set up to control each single-color LED in dependence on a set color point and a set brightness of the respective multi-color LED unit by setting the operating currents of the respective single-color LEDs with access to the calibration data. In other words, by way of the calibration data, the operating currents of the single-color LEDs are set in a manner such that the actual color point and the actual brightness correspond largely, i.e. within a specified tolerance range, to the desired (set) color point and the desired (set) brightness.

The illumination device according to the invention has the advantage that the calibration data used for operating a respective multi-color LED unit are stored locally in a microcontroller, which is a constituent part of an individual semiconductor device of the multi-color LED unit. Hereby, it is possible in a simple manner, without accessing central data, to set a desired brightness or a desired color point individually for each individual multi-color LED unit.

In a particularly preferred embodiment, the calibration data for an individual specified color point and an individual specified brightness of the respective multi-color LED unit indicate the operating currents of the respective single-color LEDs that are to be set. From these operating currents for the individual color point and the individual brightness, the microcontroller calculates operating currents of the respective single-color LEDs that are to be used for a color point, set during operation, and a brightness, set during operation. The calculation of operating currents based on such calibration data is known per se. For example, the calculation can be made based on interpolation.

In a further, in particular preferred embodiment, the microcontroller of at least some of the multi-color LED units is configured such that, when controlling a respective single-color LED, said microcontroller takes into account not only the calibration data but also the appropriately provided (instantaneous) operating temperature of the respective multi-color LED unit, such that a set color point and a set brightness can be kept constant during operation of the respective multi-color LED unit. In other words, an algorithm for temperature compensation is stored in the microcontroller, as a result of which a continuously uniform appearance of the illumination device is ensured even if temperatures vary during operation thereof. Algorithms for temperature compensation are known per se and access, for example, characteristics or tables which appropriately correct operating currents in dependence on the operating temperature of the respective multi-color LED unit.

In a further configuration of the illumination device according to the invention, integrated within the semiconductor device of at least some of the multi-color LED units is a temperature sensor, which is set up to measure the (instantaneous) operating temperature of the respective multi-color LED unit. This measured operating temperature can be processed in the above-described temperature algorithm.

In a further variant, a temperature sensor for measuring the instantaneous operating temperature is dispensed with. Instead, the microcontroller of at least some of the multi-color LED units is set up to ascertain the operating temperature of the respective multi-color LED unit based on at least some of the operating voltages and/or operating currents of the single-color LEDs of the respective multi-color LED unit. This ascertained operating temperature can be processed in the above-described temperature algorithm.

In a further preferred variant of the illumination device according to the invention, the microcontroller of at least some of the multi-color LED units is configured such that, if the (instantaneous) operating temperature exceeds a specified threshold, it reduces the brightness of the respective multi-color LED unit (i.e. the multi-color LED unit to which the microcontroller belongs). This ensures that the multi-color LED unit is not damaged due to excessive operating temperatures. In this context, a specification may be preferably made according to which the brightness of the multi-color LED unit is decreased more strongly the more the specified threshold is exceeded. If needed, the brightness of the multi-color LED unit can also be lowered to zero, i.e. the corresponding multi-color LED unit can be switched off. This can be achieved for example by way of a second threshold that is higher than the specified threshold. If the instantaneous operating temperature exceeds this second threshold, the multi-color LED unit will be switched off.

In a particularly preferred embodiment, the illumination device according to the invention comprises a plurality of multi-color LED units, which are connected to an internal databus (i.e. a databus within the illumination device). This internal databus in turn is coupled to a processing module, wherein the processing module is set up to pass internal control commands for setting the brightness and the color point of the individual multi-color LED units to the internal databus. The above processing module is preferably set up to receive external control commands from a motor vehicle databus and convert them to the above internal control commands.

In the embodiment that was just described, simple control of the individual multi-color LED units via an internal databus is achieved. The internal databus can be e.g. an SPI databus (SPI=serial protocol interface) or possibly even a different databus, such as e.g. a differential databus, which codes digital data between two lines via a voltage difference. The above motor vehicle databus can be, for example, a LIN bus (LIN=local interconnect network) or a CAN bus (CAN=controller area network).

In a further preferred embodiment, at least some of the multi-color LED units comprise one or more RGB-LED units and/or RGBW-LED units. In a manner that is known per se, an RGB-LED unit comprises a red, green and blue single-color LED, and an RGBW-LED unit comprises, in addition to a red, green and blue LED, a white light LED.

In a particularly preferred embodiment, the illumination device is an interior illumination means in a motor vehicle or possibly an exterior illumination means on the outside of the motor vehicle. Hereby, pleasing light effects with a homogeneous appearance can be generated.

In addition to the above-described illumination device, the invention relates to a motor vehicle, in particular to a passenger car or possibly also a truck, which comprises one or more of the illumination devices according to the invention or of preferred variants of said illumination devices.

Moreover, the invention relates to a method for producing illumination devices according to the invention or preferred variants of said illumination devices. The multi-color LED units for the illumination devices are produced here without any pre-sorting based on a measurement of color point and brightness of the respective multi-color LED units being performed afterward. Subsequently, before or after the assembly of the multi-color LED units to form the respective illumination devices, each multi-color LED unit individually undergoes a calibration process in which the calibration data for the respective multi-color LED unit are ascertained and saved in the microcontroller of the respective multi-color LED unit.

In the method according to the invention, the process of what is known as binning is dispensed with. In binning, to take into account manufacturing tolerances, color point and brightness of the respective multi-color LED units are measured and the multi-color LED units are classified in dependence on color point and brightness, wherein multi-color LED units having the same characteristics are assigned to the same class and correspondingly pre-sorted. Conventionally, suitable calibration data for controlling the corresponding multi-color LED unit are then used in dependence on the class to which a multi-color LED unit belongs.

In the method according to the invention, the calibration process is performed without a connected pre-sorting, and the calibration data, which are produced in that process, are immediately stored in the microcontroller of the respective multi-color LED unit. The production method is hereby significantly simplified, with the result that resources are saved during production.

In one preferred variant of the method according to the invention, in the course of the calibration process, a respective multi-color LED unit is operated and, in the process, the color point and the brightness of the respective multi-color LED unit are measured, wherein the operating currents of the respective single-color LED units are varied until one or more specified color points and brightnesses of the respective multi-color LED unit are set, wherein the operating currents which are present for the specified color point or color points and the specified brightness or brightnesses are measured and saved, in the form of calibration data, in the microcontroller of the respective multi-color LED unit together with the specified color point or points and the specified brightness or brightnesses.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic illustration of an embodiment of an illumination device according to the invention.

FIG. 2 shows a detailed view of an LED unit from FIG. 1.

### DETAILED DESCRIPTION OF THE DRAWINGS

One embodiment of the invention will be described below with reference to an illumination device that is installed in a motor vehicle in the form of interior illumination and comprises, as the light-emitting device, a multiplicity of multi-color LED units 3, which are arranged on a strip. These multi-color LED units, which will also be referred to below simply as LED units, in each case represent an individual semiconductor device having a plurality of single-color LEDs 301 to 304 and a microcontroller 4. The single-color LEDs and the microcontroller are integrated in a common package of the semiconductor device. The single-color LED 301 is a red LED, the single-color LED 302 is a green LED, the single-color LED 303 is a blue LED, and the single-color LED 304 is a white LED. With the LED units which are arranged in the manner of a strip, it is possible to achieve very high packing density (from 144 to 367 LEDs/m, depending on the type of package).

The individual LED units 3 are controlled via a digital data stream in the form of a bitstream, which is passed on to the individual LED units using an internal databus 2 (i.e. a databus that is provided internally in the illumination device). The internal databus comprises a line CL for the cycle and a line DL for the bitstream.

The signals on the internal databus 2 originate from a processing module 1, which is coupled to a LIN bus 6 of the motor vehicle. The processing module comprises a LIN transceiver 101, which taps corresponding digital signals from the LIN bus 6 for controlling the LED units 3, and a microprocessor 102, which converts the tapped signals to corresponding data signals on the data line DL. The signals that have been passed on along the LIN bus 6 comprise signals which are intended for the illumination device and define a light pattern that is to be set for the illumination device. These signals in turn originate from a controller of the motor vehicle, which defines, for example on the basis of an input by the driver, the light pattern to be generated and passes it to the LIN bus as a corresponding signal. Via the processing module 1, it is recognized whether the light pattern is provided according to the current signal on the LIN bus 6 for the illumination device. If this is the case, this signal is converted to a corresponding signal for the internal databus 2 using the microprocessor 102.

The internal databus 2 can here be an SPI bus, for example. The signals for the SPI bus are preferably produced here by the microprocessor 102 by way of software SPI. Software SPI is known per se from the prior art and represents a program library with which any free pins of the microprocessor 102 can be used to output signals to the SPI bus. Alternatively, it is possible to use hardware SPI. In this case, special SPI pins for the output of signals to the SPI bus are provided. The use of software SPI has the advantage that, in the internal databus 2, a plurality of lines DL and CL for controlling a relatively large number of LED units 3 may be provided. As an alternative to an SPI bus, the internal databus can also be configured as a differential databus or as any other desired databus. A differential databus is characterized in that it codes digital data via a voltage difference between two lines.

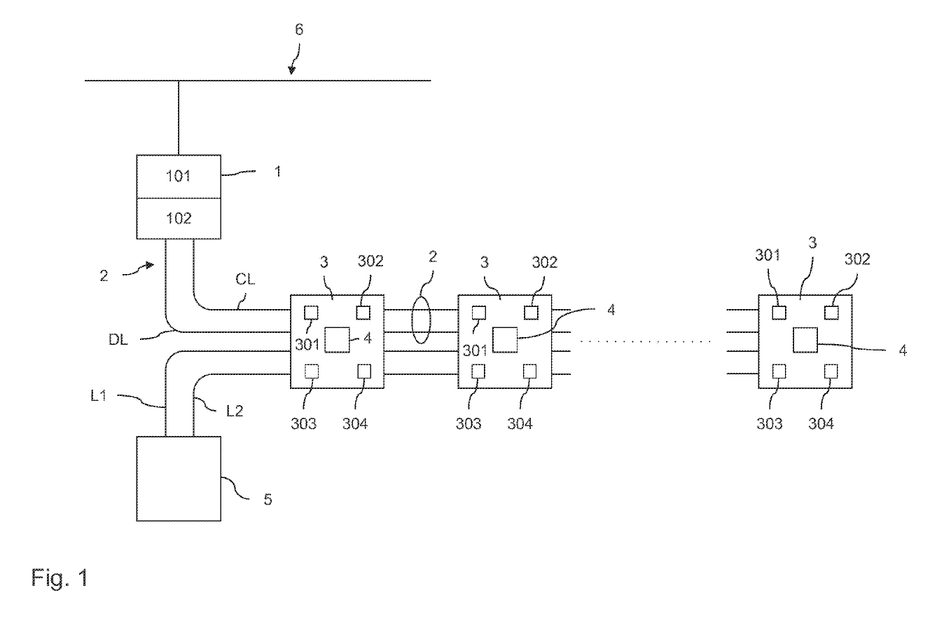

In the embodiment of FIG. 1, in addition to the lines CL and DL, two current lines L1 and L2 are provided, which are connected to a DC voltage supply 5. Based on the bitstream received by the data line DL, a PWM modulation of the current which is supplied to the individual LEDs 301 to 304 is performed in order to control hereby the LEDs in accordance with the bitstream on the data line DL.

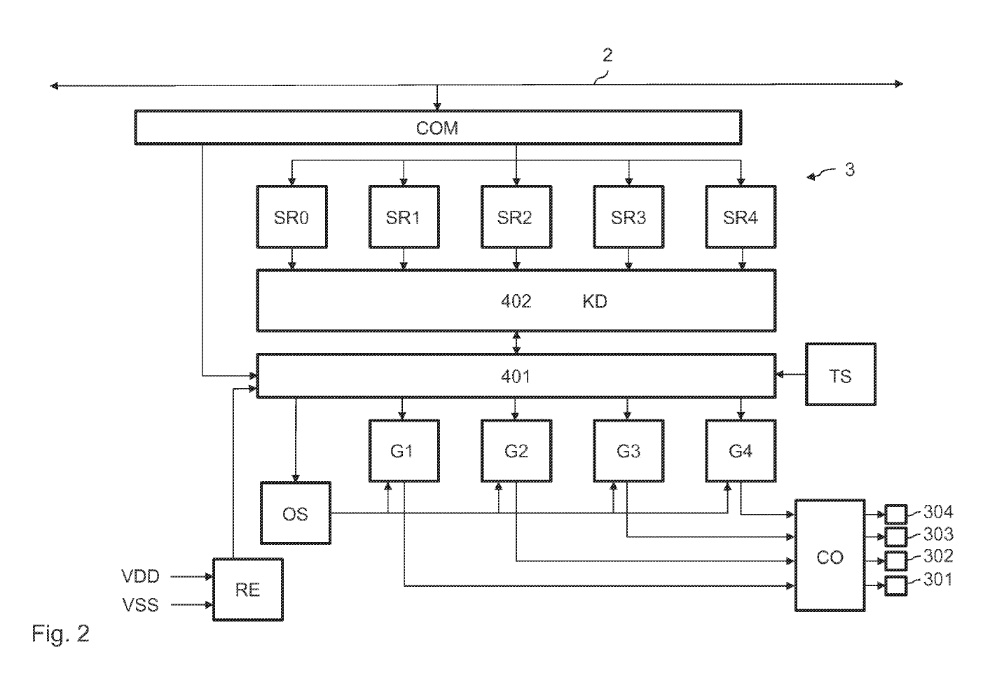

The setup of an individual LED unit 3 from FIG. 1 is shown in detail in FIG. 2. All components of the LED unit shown are integrated here in a single semiconductor device. The signals of the databus 2 are received by a communication interface COM of the LED unit 3. The cycle signal of the cycle line CL is passed on to the microprocessor 401 (described further below), whereas the data stream is passed to the data line DL after decoding in the communication interface COM on 8-bit shift registers SR0, SR1, SR2, SR3 and SR4. The value output by the shift register SR0 here shows the desired total brightness of the LED unit, whereas the color components of the individual single-color LEDs are output for producing the desired mixed color via the values of the shift registers SR1 to SR4. In particular, the color component of the red LED 301 is output by the shift register SR1, the color component of the green LED 302 is output via the shift register SR2, the color component of the blue LED 303 is output by the shift register SR3, and the color component of the white LED 304 is output by the shift register SR4.

The values of the individual shift registers are fed to the microcontroller 4, which consists of a logic or a microprocessor 401 and an associated non-volatile EEPROM memory 402. Saved in this memory are calibration data KD, which originate from a calibration process of the LED unit and define for a specified standard temperature value of the LED unit how the operating currents of the individual single-color LEDs are to be set so that the total brightness value originating from the shift register SR0 and the color mixture (i.e. the color point in this respect) according to the values from the shift registers SR1 to SR4 are achieved. In the embodiment described here, the calibration data for an individual predetermined mixed color (preferably a white color), i.e. for a corresponding color point in the color space, and for an individual predetermined brightness value of the multi-color LED unit, define the operating currents that are to be set. The microprocessor 401 accesses the calibration data KD during the operation of the multi-color LED unit and calculates, based on an appropriate interpolation, the operating currents of the individual single-color LEDs which are to be set for the currently set color point and the currently set brightness of the multi-color LED unit.

In the embodiment described here, furthermore saved in the microprocessor 401 is a temperature algorithm with which it is taken into account that the calibration data for a standard temperature value have been ascertained and correspondingly must be adapted in the case of a deviation of the operating temperature of the LED unit from this standard temperature. This adaptation is performed via the temperature algorithm, wherein herefor the instantaneous temperature of the LED unit is captured by a temperature sensor TS and made available to the microprocessor 401. In a manner known per se, the operating currents which were originally ascertained for the standard temperature value are then corrected by the temperature algorithm. For this purpose, the microprocessor 401 can access for example characteristics or tables which are saved in the memory 402 and indicate the corresponding corrections for different operating temperatures. It is thus ensured with the temperature algorithm that the desired brightness and the desired color point in accordance with the values from the shift registers are also correctly set in the case of temperature variations.

The operating currents for the individual LEDs 301 to 304 are provided via a voltage regulator RE, which receives the positive voltage VDD and the negative voltage VSS from the voltage supply 5 shown in FIG. 1. The microprocessor 401 furthermore generates a cycle for a corresponding oscillator OS, which is passed on to PWM generators G1, G2, G3 and G4. The operating currents of the individual LEDs 301 to 304 are produced in the generators G1 to G4 via pulse width modulation. The values of the operating currents originating from the microprocessor are passed on to the individual generators G1 to G4. The generator G1 produces the current for the red LED 301 using pulse width modulation, the generator G2 produces the current for the green LED 302, the generator G3 produces the current for the blue LED 303, and the generator G4 produces the current for the white LED 304. Via the PWM signals generated by the individual generators, which reach the single-color LEDs via the current output CO, the corresponding light is then set with the desired brightness and the desired color point for the LED unit 3 in accordance with the signal which reaches the LED unit via the internal databus 2.

In the embodiment just described, the instantaneous temperature value is measured by a temperature sensor TS on the semiconductor device of the LED unit 3. There may also be the possibility, instead of measuring a temperature value, of ascertaining the instantaneous temperature by way of characteristics which indicate for respective operating currents a relationship between the operating voltage of the individual single-color LEDs and the temperature of the LED unit. The operating voltage can be measured by a suitable voltage sensor in the LED unit. A type of temperature ascertainment of this type is known to a person skilled in the art and is described for example in document US 2015/0002023 A1.

The illumination device described above is preferably produced by way of a novel production method, in which what is known as binning is dispensed with. In binning, the multi-color LED units are measured after production with respect to color point and brightness and classified in dependence on color point and brightness. Based on this classification, the LED units are then pre-sorted, i.e. LED units of the same class are collected separately. In accordance with the novel production method, the multi-color LED units produced are collected without pre-sorting. Subsequently, for each individual multi-color LED unit, a calibration process is performed in which calibration data of the individual LED unit are ascertained and immediately recorded on the microcontroller. The LED units together with the calibration data which are recorded thereon are then assembled to form the respective illumination devices, where in each case the assembly can also be performed before the calibration of the individual LED units.

The invention explained above has a number of advantages. In particular, for the first time, calibration data are saved directly in a microcontroller which is integrated in the semiconductor device of a multi-color LED unit. As a result, it is ensured in the individual LED units using local information in a simple manner that the illumination device emits light with a desired brightness and a desired color point. Moreover, such an illumination device can be produced by way of a very simple production method, in which pre-sorting of the multi-color LED units is dispensed with.

### LIST OF REFERENCE SIGNS

1 processing module
101 LIN transceiver
102 microprocessor
2 internal databus
3 multi-color LED units
301, 302, 303, 304 single-color LEDs
4 microcontroller
401 microprocessor
402 EEPROM
5 voltage supply
6 motor vehicle databus
CL line for cycle signal
DL data line
L1, L2 current lines
COM communication interface
SR0, SR1, SR2, SR3, SR4 shift registers
KD calibration data
TS temperature sensor
G1, G2, G3, G4 PWM generators
OS oscillator
RE voltage regulator
VDD, VSS voltages
CO current output

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An illumination device, comprising:
one or more multi-color LED units which each have a settable color point and a settable brightness, wherein
each multi-color LED unit is an individual semiconductor device with multiple single-color LEDs of different colors and a microcontroller,
the single-color LEDs and the microcontroller are enclosed by a package of the semiconductor device,
stored in the microcontroller are calibration data which describe a dependence of operating currents of the single-color LEDs on at least one color point and at least one brightness of the respective multi-color LED unit, and
the microcontroller is configured to control each single-color LED in dependence on a set color point and a set brightness of the respective multi-color LED unit by setting the operating currents of the respective single-color LEDs with access to the calibration data.

2. The illumination device as claimed in claim 1, wherein
the calibration data for an individual specified color point and an individual specified brightness of the respective multi-color LED unit indicate the operating currents of the respective single-color LEDs that are to be set, wherein, from the color point and brightness, the microcontroller calculates the operating currents of the respective single-color LEDs that are to be used for a set color point and a set brightness.

3. The illumination device as claimed in claim 1, wherein
the microcontroller of at least some of the multi-color LED units is configured such that, during control of a respective single-color LED, it furthermore takes into account the operating temperature of the respective multi-color LED unit,
whereby a set color point and a set brightness are kept constant during the operation of the respective multi-color LED unit.

4. The illumination device as claimed in claim 1, wherein
integrated in the semiconductor device of at least some of the multi-color LED units is a temperature sensor, which is set up to measure the operating temperature of the respective multi-color LED unit.

5. The illumination device as claimed in claim 1, wherein
the microcontroller of at least some of the multi-color LED units is configured to ascertain the operating temperature of the respective multi-color LED unit on the basis of at least some of the operating voltages and/or operating currents of the single-color LEDs of the respective multi-color LED unit.

6. The illumination device as claimed in claim 1, wherein
the microcontroller of at least some of the multi-color LED units is configured such that, if the operating temperature of a respective multi-color LED unit exceeds a specified threshold, it reduces the brightness of the multi-color LED unit.

7. The illumination device as claimed in claim 1, wherein
the illumination device comprises a plurality of multi-color LED units, which are connected to an internal databus, which is coupled to a processing module, and
the processing module is configured to pass internal control commands for setting the brightness and the color point of the individual multi-color LED units to the internal databus.

8. The illumination device as claimed in claim 7, wherein
the processing module is configured to receive external control commands from a motor vehicle databus and convert them to the internal control commands.

9. The illumination device as claimed in claim 1, wherein
at least some of the multi-color LED units comprise one or more RGB-LED units and/or RGBW-LED units.

10. The illumination device as claimed in claim 1, wherein
the illumination device is an interior illumination device in a motor vehicle or an exterior illumination device on an exterior of the motor vehicle.

11. A motor vehicle, comprising one or more illumination devices as claimed in claim 1.

12. A method for producing illumination devices each of which comprise one or more multi-color LED units with a respectively settable color point and settable brightness, each multi-color LED unit being an individual semiconductor device with a plurality of single-color LEDs of different colors and a microcontroller, the single-color LEDs and the microcontroller being enclosed by a package of the semiconductor device,
the method comprising the steps of:
producing the multi-color LED units for the illumination devices without any presorting based on a measurement of color point and brightness of the respective multi-color LED units being performed after their production;
subsequently, either before or after an assembly of the multi-color LED units to form a respective illumination device, individually calibrating each multi-color LED unit, wherein calibration data for the respective multi-color LED unit are determined and stored in the microcontroller of the respective multi-color LED unit.

13. The method as claimed in claim 12, wherein
during the calibrating step, the respective multi-color LED unit is operated and, in the process, the color point and the brightness of the respective multi-color LED unit are measured, wherein
operating currents of the respective single-color LED units are varied until one or more specified color points and brightnesses of the respective multi-color LED unit are set, and
the operating currents present for the specified color point or points and the specified brightness or brightnesses are measured and saved, in the form of calibration data, in the microcontroller of the respective multi-color LED unit together with the specified color point or points and the specified brightness or brightnesses.
